(19) United States
(12) Patent Application Publication
(10) Pub. No.: US 2026/0127780 A1
(43) Pub. Date: May 7, 2026

(54) COMPUTING SYSTEM PARTITION GENERATOR

(71) Applicant: Tesla, Inc., Austin, TX (US)

(72) Inventors: Prateek Agrawal, San Jose, CA (US); Chandrasekhar Poorna, Sunnyvale, CA (US); Ankit Jalote, San Jose, CA (US); Hadi Goudarzi, Mountain View, CA (US)

(21) Appl. No.: 19/114,385

(22) PCT Filed: Sep. 28, 2023
(86) PCT No.: PCT/US2023/033993

§ 371 Date: Mar. 21, 2025

Related U.S. Application Data
(60) Provisional application No. 63/378,029, filed on Sep. 30, 2022.

(51) Int. Cl. G06T 11/00

(52) U.S. Cl. CPC G06T 11/00; G06T 2210/04

(57) ABSTRACT

The present disclosure relates to a computing device and methods for generating graphical representation of one or more portions of a computing system. The computing device can include a computing processor and memory and configured to access configuration information identifying partitions of the computing system, wherein the computing system comprises an array of system on a wafers (SoWs), and each SoW of the array of SoWs comprises an array of dies; and generate a graphical representation of at least a portion of the computing system, wherein the graphical representation identifies the partitions and individual dies of the partitions.

### CROSS-REFERENCE TO PRIORITY APPLICATION

This application claims the benefit of priority of U.S. Provisional Application No. 63/378,029, filed Sep. 30, 2022, and titled “SYSTEM ON WAFER PARTITION GENERATOR,” the disclosure of which is hereby incorporated by reference in its entirety and for all purposes.

### BACKGROUND

### Technical Field

This disclosure relates generally to partitioning and/or generating a graphical representation of a computing system.

### Description of Related Technology

Certain computing systems can be used in and/or specifically configured for high performance computing and/or computationally intensive applications, such as neural network training, neural network inference, machine learning, artificial intelligence, complex simulations, or the like. In some applications, a computing system can be used to perform neural network training. For example, such neural network training can generate data for an autopilot system for vehicle (e.g., an automobile), other autonomous vehicle functionality, or Advanced Driving Assistance System (ADAS) functionality.

In high performance computing systems, there can be a high density of processing dies. It can be desirable to analyze one or more portions of the high density of dies for analyzing and debugging the high density of dies. In computing systems with a large number of processing dies, there are technical challenges associated with analyzing and debugging the dies and the associated computing system.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a computing device for generating a graphical representation of a computing system. The computing device includes a computing processor and a memory storing computer-executable instructions, that when executed by the computing processor, cause operations to be performed, the operations include accessing configuration information identifying partitions of the computing system and generating a graphical representation of at least a portion of the computing system. The computing system includes an array of system on a wafers (SoWs), and each SoW of the array of SoWs comprises an array of dies. In addition, the graphical representation identifies the partitions and individual dies of the partitions.

In the computing device, the graphical representation can provide information associated with functionality of the individual dies of the partitions. Additionally, the information associated with functionality of individual dies of the partitions can indicate whether each of the individual dies is functional, partially functional, or non-functional.

In the computing device, the configuration information can define a voltage supply level and a clock frequency for each of the partitions.

In the computing device, the operations can further include checking for an illegal configuration of the configuration information.

In the computing device, the operations can further include dynamically generating the partitions.

In the computing device, the operations can further include generating a second graphical representation of dies of a partition of the partitions, and the second graphical representation can indicate an error on one or more nodes of a particular die of the partition

In the computing device, the computing device can include a display configured to display the graphical representation.

Another aspect of this disclosure is a method of generating a graphical representation of a computing system. The method includes accessing configuration information identifying partitions of the computing system and generating a graphical representation of at least a portion of the computing system. The computing system includes an array of system on a wafers (SoWs), and each SoW of the array of SoWs comprises an array of dies. In addition, the graphical representation identifies the partitions and individual dies of the partitions.

In the method, the graphical representation can provide information associated with functionality of the individual dies of the partitions. Additionally, the information associated with functionality of individual dies of the partitions can indicate whether each of the individual dies is functional, partially functional, or non-functional.

In the method, the configuration information can define a voltage supply level and a clock frequency for each of the partitions.

In the method, the method can further include checking for an illegal configuration of the configuration information.

In the method, the method can further include dynamically generating the partitions.

In the method, the method can further include generating a second graphical representation of dies of a partition of the partitions, wherein the second graphical representation indicates an error on one or more nodes of a particular die of the partition.

In the method, the method can further include displaying graphical representation on a display.

Another aspect of this disclosure is a non-transitory computer-readable storage medium. The storage medium includes instructions that, when executed by one or more processors, cause to perform the method of accessing configuration information identifying partitions of the computing system and generating a graphical representation of at least a portion of the computing system. The computing system includes an array of system on a wafers (SoWs), and each SoW of the array of SoWs comprises an array of dies. In addition, the graphical representation identifies the partitions and individual dies of the partitions.

For purposes of summarizing the disclosure, certain aspects, advantages, and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting examples, with reference to the accompanying drawings.

FIG. 1 illustrates an example of a system tray and associated cabinets according to an embodiment.

FIG. 2 is a schematic diagram of an example computing system in accordance with various embodiments disclosed herein.

FIG. 3 illustrates an example of a computing system in accordance embodiments disclosed herein.

FIG. 4A illustrates an example of a system on a wafer (SoW) that includes a die array.

FIG. 4B illustrates an example of nodes included in a die.

FIG. 5A illustrates an example of a block diagram of an example computing system and a computing device, according to various embodiments of the present disclosure.

FIG. 5B illustrates an example of a command interface according to embodiments disclosed herein.

FIG. 5C illustrates an example graphical representation of dies of a SoW array according to embodiments disclosed herein.

FIG. 5D illustrates an example of a command interface provided to generate a partition of SoW array according to embodiments disclosed herein.

FIG. 5E illustrates an example of a graphical representation of a 3 by 2 array of SoWs according to embodiments disclosed herein.

FIG. 5F illustrates an example graphical representation of nodes of a partition of a 2 by 2 array of dies according to the embodiments disclosed herein.

FIG. 5G illustrates a graphical representation of a 2 by 2 array of instances of a single SoW according to the embodiments disclosed herein.

FIG. 6 depicts one embodiment of the architecture of a computing device according to some embodiments disclosed herein.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals and/or terms can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

This disclosure relates to a partition generator for a computing system and uses of the partition generator, such as generating graphical representations of a computing system, dynamic partitioning, and using the partition generator to test a single system on a wafer. For example, aspects of the present disclosure provide a system for automatically partitioning one or more systems on wafers (SoWs). In some aspects, the partition can be defined in various scales or levels of hierarchy, such that the partition can include a portion of a SoW, a single SoW, dies of more than one SoW, or a plurality of SoWs. The system disclosed herein can identify hierarchical representations of the computing system by identifying SoW arrangements and die arrangements of each SoW. The system can also generate the partitions based on identifying one or more of these arrangements. In some aspects, one or more of the partitions can be represented graphically to visualize such partition(s) in the context of various hierarchical representations. The graphical representations can be useful in debugging the computing system.

In various aspects of the present disclosure, a computing system can include one or more computing tiles, and each computing tile can include a system on wafer (SoW) and be configured to perform computing tasks of the computing system. According to some embodiments, each SoW can include a plurality of dies. For instance, each SoW can include an array of integrated circuit dies (hereinafter “dies”). Using SoWs, the computing system can achieve a high compute density. The SoW can include an integrated cooling system. A system tray can include an array of SoWs supported by a common structure and connected to each other. System trays can be arranged within a computing cabinet. SoWs of adjacent computing cabinets can be connected to each other in a computing system. Any suitable number of SoWs and dies in each SoW can be used in accordance with any suitable principles and advantages disclosed herein.

As the demand for computing resources of a computing system increases, a high density computing system is desired. As discussed above, certain computing systems can include one or more SoWs, and each SoW can include an array of dies. During the computing operations or prior to installing the SoWs in a computing system, the performance of the SoWs can be monitored and/or tested to ensure that performance will meet design specifications. However, monitoring the operation and/or performance of such a computing system can be challenging. For example, one or more dies of SoWs can have decreased performance, and these one or more dies decreased performance may cause the overall performance degradation of the computing system.

Traditionally, extensive computing resources have been involved in monitoring the performance of large computing systems. Identifying particular parts of such a computing system with decreased performance and/or errors and performing post-processing (e.g., debugging) to ensure that the performance meets its desired specification has involved significant computing resources. For example, in a system with 6 SoWs where each SoW includes a 5 by 5 array of dies, the traditional system may analyze all 150 dies included in the computing system to assess performance. Additionally, the traditional system may not be able to easily detect one or more specific dies that cause decreased performance in such a system in real time. For example, the traditional system may obtain system logs, store the obtained logs, and analyze the logs. These deficiencies of the traditional system can lead to performance degradation of the computing system as a whole if one or more of dies of its SoWs become inoperable or experience decreased performance. Furthermore, upon determining that the computing system has decreased performance, determining which dies of the SoWs caused the decreased performance by analyzing the whole computing system, such as logs of the whole computational logs, could lead to inefficient utilization of the computing resources within the computing system.

To address at least a portion of the above-described technical challenges, one or more aspects of the present disclosure correspond to a computing device that can perform partitioning of the computing system in various hierarchies of the system and generate graphical representations of the computing system. Illustratively, the computing device disclosed herein can be communicatively coupled with the computing system and can partition the SoWs included in the computing system. Then, the computing device can analyze the partitioned SoWs (e.g., dies included in the partitioned SoW) to identify the performance metrics of the dies and perform debugging its operation upon identifying that the performance metrics do not meet a specific computing performance specification. The present disclosure is not limited to the specific computing performance specifications disclosed herein, and it can be determined based on specific applications.

As disclosed herein, the SoWs of a computing system can be partitioned, and the performance of individual dies included in the partitioned SoWs can be monitored and analyzed to determine whether these dies are providing computational performance as desired (or designed). For instance, a single SoW can include 25 dies, each configured to provide its performance data. For example, the performance metrics of each die can be measured based on telemetry data provided by the respective die. Thus, the performance of each SoW can be determined based on the measured performance metrics of each die. More specifically, each die can include one or more nodes designed to measure their neighbor nodes'performance metrics. The performance of the SoW is then determined based on these measured performance metrics from the associated dies.

In some aspects of the present disclosure, after the SoWs have been partitioned, the partitioned SoWs can include one or more dies, the performance of which can be monitored. The process of partitioning the SoWs and analyzing the dies within the divided SoWs can be advantageous as it can allow for efficient use of computing resources when investigating the cause of any decrease in the computing system's performance or failure of the computing system. For example, if the computing system's performance declines, the computing device described here can partition a section of the SoWs and identify the factors leading to the performance drop. This can be more efficient than traditional systems that involve analysis of entire SoWs.

Moreover, if new SoWs are added to the computing system, the computing device can monitor the performance metrics of these newly added SoWs by partitioning them. Therefore, the systems and methods disclosed herein can allow for efficient use of computing resources when analyzing operational metrics of the computing system and identifying any dies causing performance degradation. The performance metrics in this disclosure can include but are not limited to power consumption, utilization rate, availability, throughput, computational latency, and the like.

Although embodiments disclosed herein may relate to computing systems with SoWs, any suitable principles and advantages disclosed herein can be applied to computing systems, including a plurality of dies that are partitioned for performing computing tasks.

The principles and advantages disclosed herein can be applied to any suitable computing device. Although aspects of the present disclosure will be described with regard to illustrative computing components and interactions, one skilled in the relevant field of technology will appreciate that one or more aspects of the present disclosure may be implemented in accordance with various environments, system architectures, computing device architectures, and the like. Additionally, the examples are intended to be illustrative in nature and should not be construed as limiting.

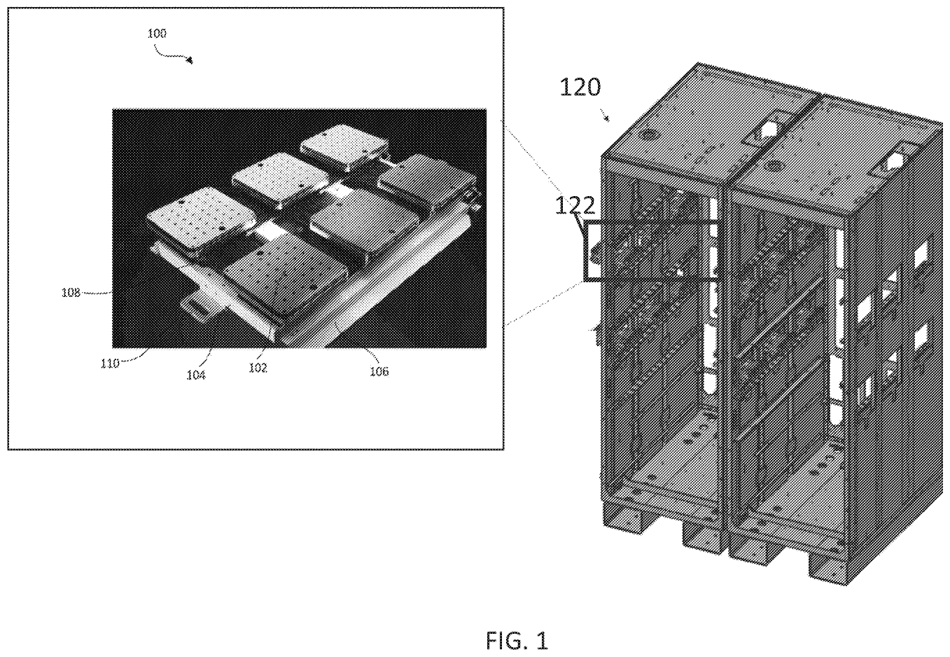

In non-limiting examples, a plurality of SoWs can be implemented as computing resources of a computing system. For example, as illustrated in FIG. 1, the plurality of SoWs can be implemented in one or more cabinets, such as a cabinet 120 as illustrated in FIG. 1.

FIG. 1 illustrates an example of a system tray 100 according to an embodiment. As illustrated, the system tray 100 can include an array of computing tiles 102 connected to each other and supported by a structural busbar 104. The structural busbar 104 can provide structural support and deliver power to the computing tiles 102 positioned thereon. In certain embodiments, each computing tile 102 includes SoW that includes an array of dies integrated with a cooling solution (e.g., a cold plate). The computing tiles 102 can be referred to as training tiles in neural network training applications. Any suitable number of computing tiles 102 can be connected to each other on a system tray 100. For example, FIG. 1 illustrates six computing tiles 102 connected to each other. The system tray 100 can include intra-tray signal delivery cables 108 to facilitate the communication between each computing tile 102 and an external connection hub (not shown). The computing tiles 102 can each include a SoW.

The computing tiles 102 can be positioned close to each other such that connections between the computing tiles 102, such as those established through the intra-tray signal delivery cables 108, are relatively short to promote high-speed connectivity. The system tray 100 can operate at relatively high power while maintaining mechanical integrity and dissipating sufficient heat to operate at a suitable temperature. The illustrated system tray 100 can support dense integration. For example, the system tray 100 can support a considerable mass while maintaining a relatively small height.

As further illustrated in FIG. 1, the system tray 100 can include stepped edges 106 positioned along the length of opposing sides of the system tray 100. The stepped edges 106 can facilitate sliding the system tray 100 in and out of a cabinet, such as computing cabinet 120. The system tray 100 can be moved in and out of the cabinet 120 via the slot 122. The system tray 100 can include handle 110 to help facilitate moving the system tray 100 in and out of a cabinet. The structural busbar 104 can include multiple layers that provide structural and electrical support for the computing tiles 102. Even though FIG. 1 describes the specific structure of the system tray 100 and cabinet 120, any suitable principles and advantages disclosed herein can be applied to any suitable computing system.

In some embodiments, the computing tile 102 can include one or more of a cooling system, voltage regulator modules, a frame structure, a SoW, and a heat dissipation structure. An example of the computing tile 102 is disclosed in International PCT Application No. PCT/US2022/040420, titled “CONNECTOR SYSTEM FOR CONNECTING PROCESSOR SYSTEMS AND RELATED METHODS,” the disclosure which is hereby incorporated by reference herein in its entirety. In certain applications, the computing tile 102 can include a communication interface to communicate data with a computing device. For example, a computing device, as disclosed herein, can receive data from one or more SoWs included in the computing tiles 102 and perform partitioning the SoWs according to the embodiments disclosed herein. In addition, the computing device can analyze the performance of the partitioned SoWs (e.g., dies included in the partitioned SoWs) and generate graphical representations of the analyzed performance of the dies and/or SoWs. In some applications, the cabinet 120 includes a communication interface and controller to communicate coupled with the computing device. The present application is not limited to the number of SoWs communicatively coupled with the computing device.

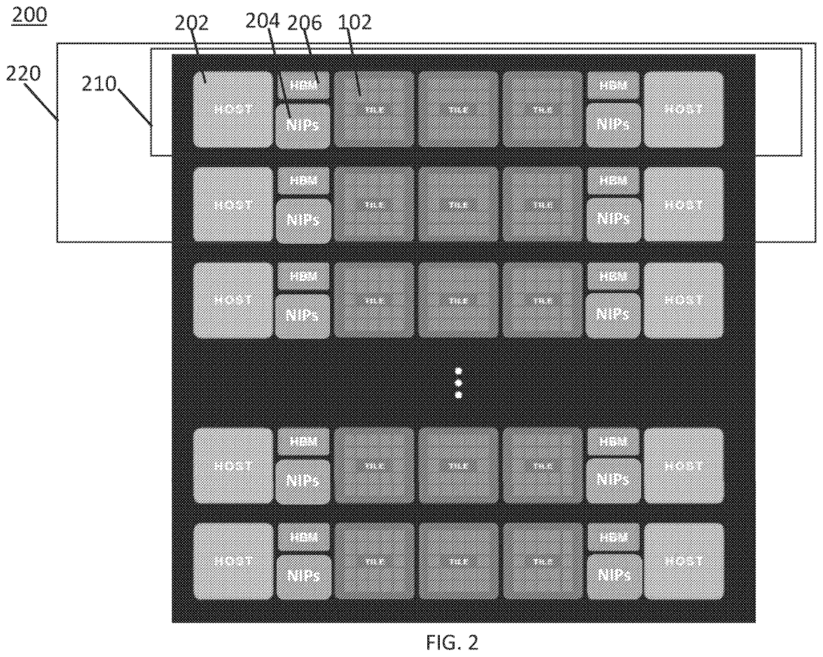

FIG. 2 illustrates an example of computing system 200 in accordance with various embodiments disclosed herein. The computing system 200 can be implemented in several computing cabinets and function as one computing system that can be partitioned to perform a variety of computing tasks. As depicted in FIG. 2, computing system 200 can comprise several computing tiles 102. In certain scenarios, these computing tiles 102 can be linked with peripheral components and implemented as part of computing system 200. Peripheral components may include, but are not limited to, a host 202 and interface processors such as network interface processors (NIP) 206.

In various scenarios, host 202 can be used to identify host addresses associated with one or more computing tiles 102. For instance, the hosts 202 in group 210 can provide a specific host address to the computing tiles 102 within group 210, allowing these computing tiles 102 to share a host address provided by the hosts 202.

In some scenarios, NIPs 204 can facilitate communication between the computing tiles 102. For instance, a computing tile 102 can exchange data with adjacent computing tiles 102. In other scenarios, the computing tile 102 may communicate data with a computing device via the NIPs 204. A computing device, for example, may receive configuration information for each computing tile 102 through the NIPs 204 and via a host 202.

In some scenarios, the dies within each computing tile 102 can provide data related to their performance via the NIPs 204. For instance, a die within a computing tile 102 can transmit data indicating the availability of its computing node to the computing device via one of the NIPs 204 and a host 202.

In certain embodiments, peripheral components can also include memory, such as high bandwidth memory (HBM) 206. In various non-limiting examples, system tray 100 (shown in FIG. 1) can include six computing tiles 102 of group 220. The group 220 can also include respective peripheral components, including NIPs 204, HBMs 206, and hosts 202.

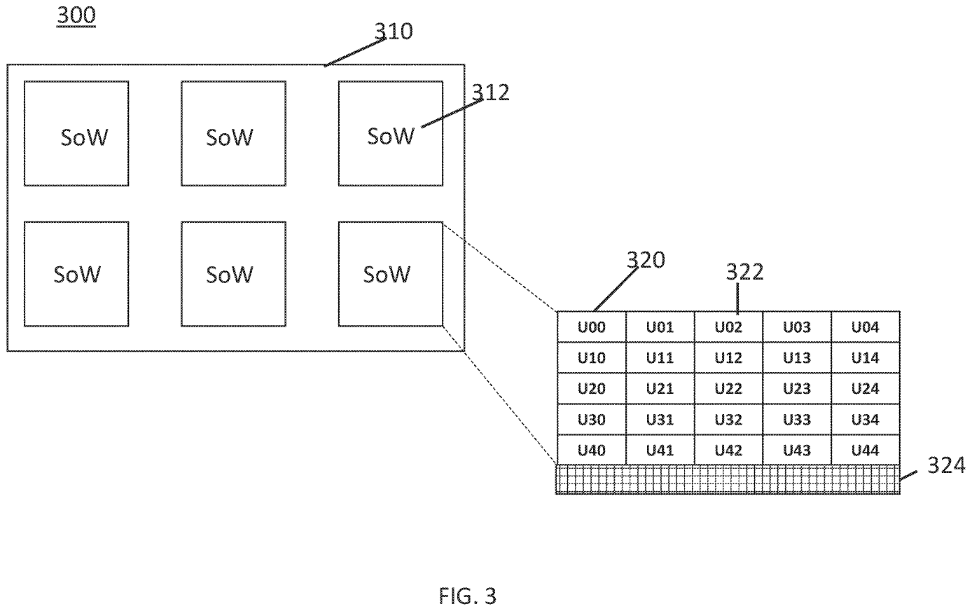

FIG. 3 illustrates an example of computing system 300 in accordance with embodiments disclosed herein. As shown in FIG. 3, the computing system 300 can include a SoW array 310. Each SoW 312 of the SoW array 310 can be included in a respective computing tile 102 of FIG. 1, for example. The SoW array 310 can include SoWs 312 on one or more system trays and/or within one or more cabinets. The SoW array 310 can be utilized as computing resources of the computing system 300. The number of SoWs 312 of the SoW array 310 can be determined based on specific applications.

Each SoW 312, as shown in FIG. 3, can include a die array 320. The die array 320 can include the dies 322, for example, as further illustrated in FIG. 3. As illustrated in FIG. 3, each die 322 can be arranged in the die array 320 and can be logically represented with the array address, such as U00-U44. In some embodiments, an interface processor 324 can communicate with an NIP 204 of FIG. 2. The interface processor 324 can receive information from the host 202 of FIG. 2 via the NIP 204. The interface processor 324 can communicate with the NIP using an Ethernet protocol. In various examples, any suitable number of dies 322 can be included in the SoW 312.

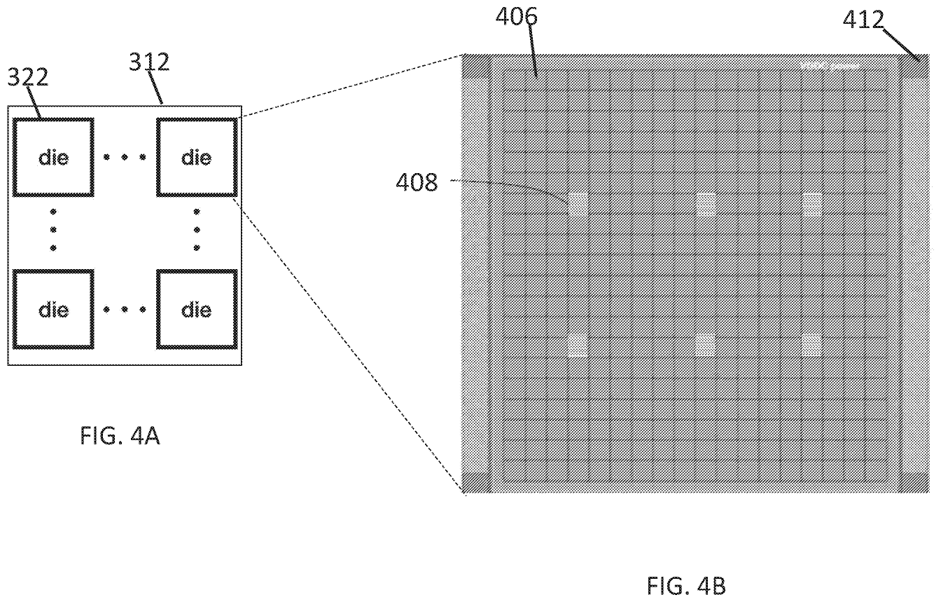

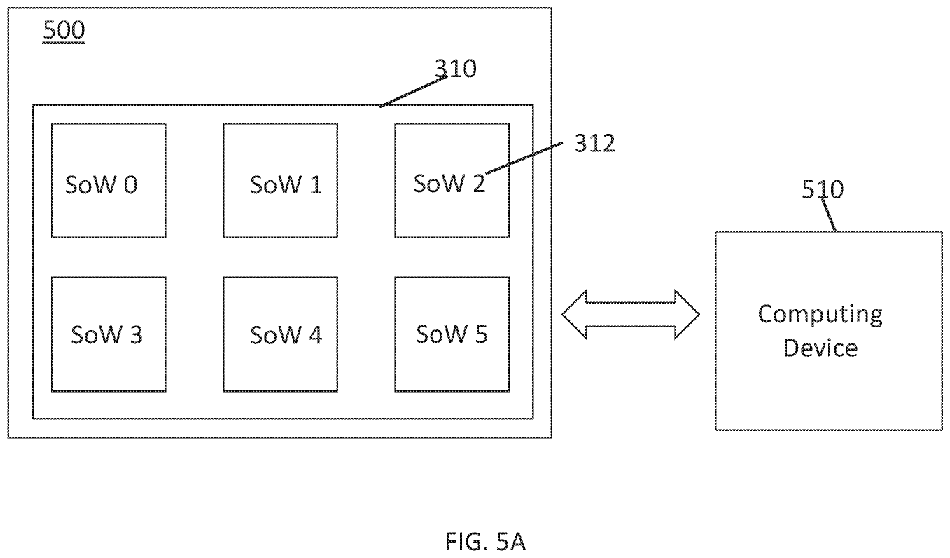

FIG. 4A illustrates an example of SoW 312 that includes a die array 320 that includes dies 322. The dies 322 can each be an integrated circuit die. The dies 322 can be implemented on the SoW 312 that is packaged with a wafer-level packaging structure.

As shown in FIG. 4B, in some embodiments, the die 322 can include an array of nodes. The array of nodes can include compute nodes 406 and global nodes 408. In some embodiments, the compute nodes 406 can include circuitry for performing processing tasks. The global nodes 408 can generate telemetry data for the die 322. The global nodes 408 may not include circuitry for performing processing tasks. For example, the global nodes 408 may include pressure, voltage, and temperature (PVT) sensors to monitor the operating conditions of the die 322. In some implementations, compute nodes 406 and global nodes 408 may both include communication interfaces to enable communication with neighboring nodes. For example, each global node 408 can monitor the operating voltage of the surrounding nodes by receiving the current supply voltage from the neighboring nodes via the communication interfaces. In some implementations, the communication interfaces for compute nodes 406 may be the same as the communication interfaces for global nodes 408.

In some embodiments, each die 322 can provide performance data associated with each node 406. The performance data can refer to information generated from each die. The performance data can include but is not limited to, environmental information, such as surrounding and/or operating temperature of die(s), operational parameters, such as power supply to each die, current and/or voltage measurements for the die(s), and performance information, such as usage of die(s), bandwidth, and/or latency. The performance data can include data regarding the functionality of portions of the die 322, such as each compute node 406. Each die 322 can be configured to communicate data from the SoW 312 via an input/output interface 412. The input/output interface 412 can also be connected with the interfacing processor 324 (shown in FIG. 3). In this example, the global nodes 408 can be configured to provide its data to the SoW 312 via interface 412. In some scenarios, the global nodes 408 may continuously monitor the operation parameters of the compute node 406 by enabling the communication interfaces with the neighboring compute nodes 406. Furthermore, the global nodes 408 may continuously measure the operating temperature of the die 322.

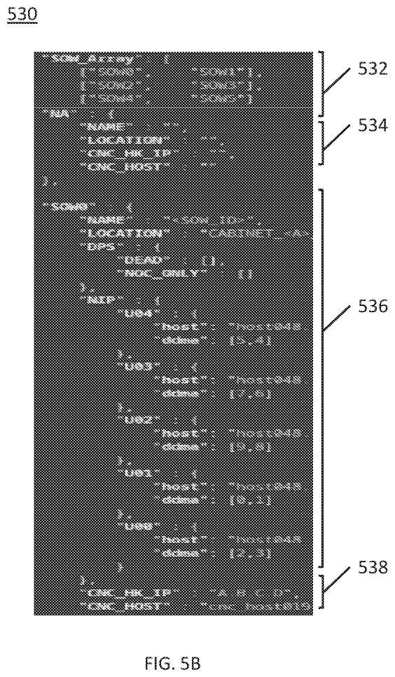

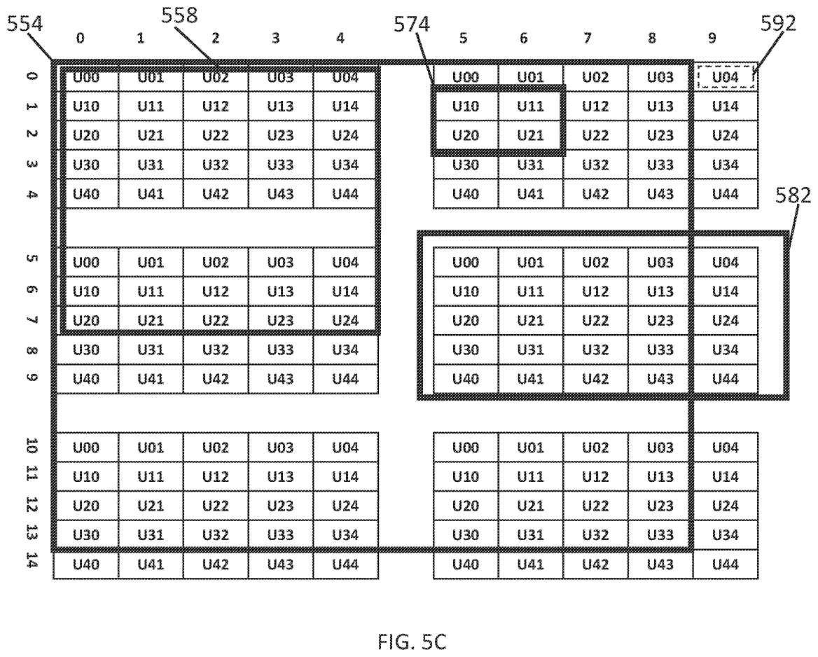

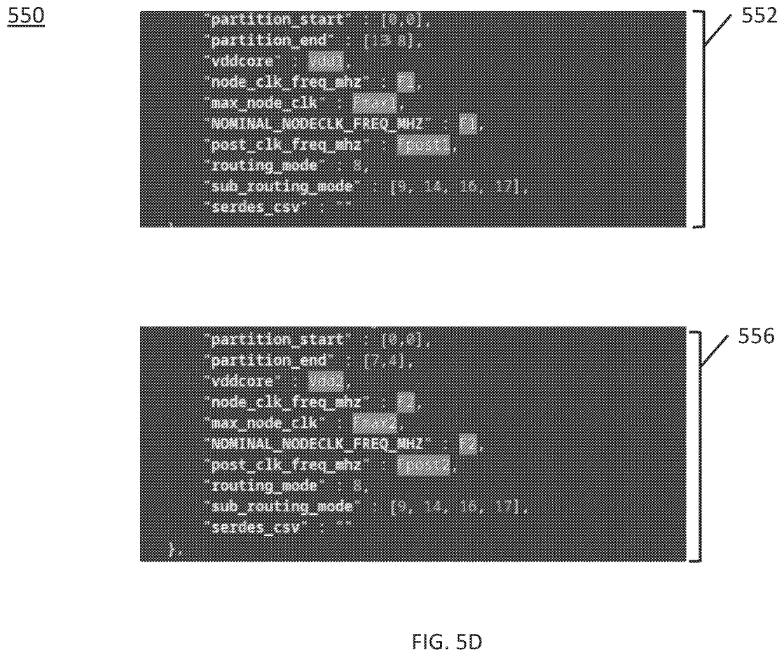

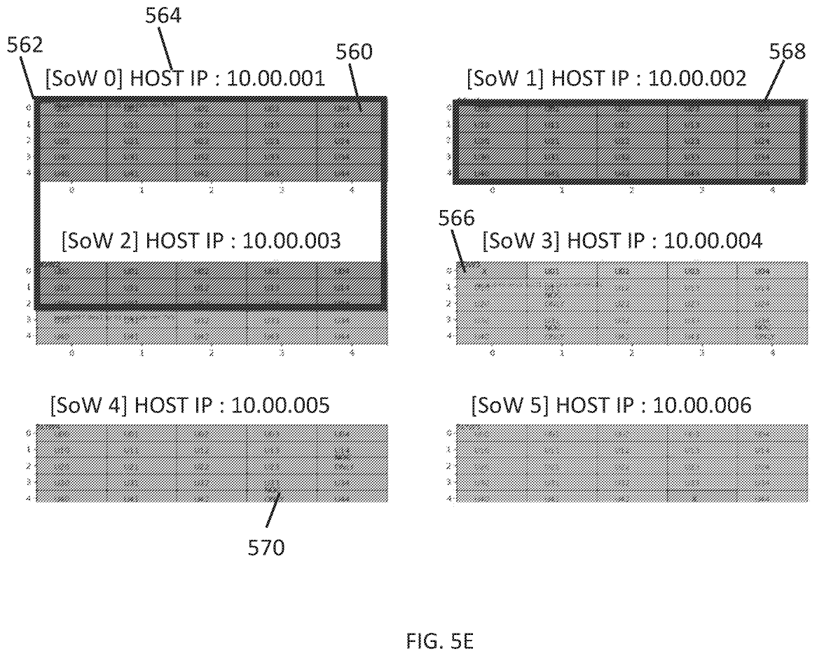

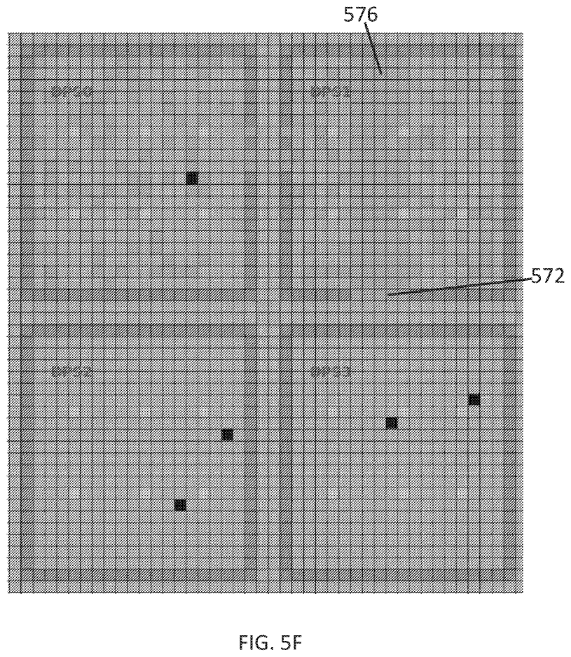

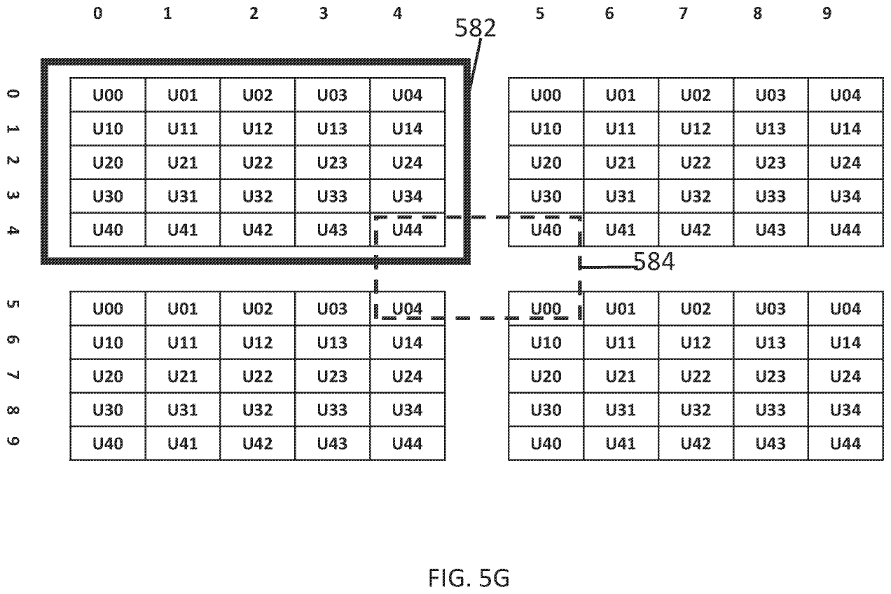

FIG. 5A illustrates an example of a block diagram of the computing system 500 and a computing device 510, according to various embodiments of the present disclosure. The computing system 500 can correspond, for example, to the computing systems 200 and/or 300, as described in FIGS. 2 and 3, respectively. For instance, the computing system 500 can include at least the SoW array 310 including SoWs 312. In some embodiments, the computing system 500 can be communicatively coupled with the computing device 510. The SoWs 312 can be in communication with the computing device 510 via NIPS and hosts. In some instances, the computing system 500 and computing device 510 are connected via a network, which can be wireless or wired. This network can comprise any combination of wired and/or wireless networks, such as one or more direct communication channels, local area networks, wide area networks, personal area networks, and/or the Internet. The network can include a specific type of data bus used for transmitting data.

In some embodiments, the computing device 510 can include any suitable computing device(s), such as one or more server computers, one or more desktop computers, or the like. In some embodiments, the computing device 510 can store instructions and execute the instructions to perform one or more operations of the embodiments disclosed herein. In various embodiments, a user (e.g., system operator, administrator, developer, etc.) may interact with the computing system 500 by utilizing the computing device 510. In some embodiments, such interactions can be accomplished via interactive graphical user interfaces, via command line, and/or any other suitable means. For example, the graphical user interfaces of the computing device 510 may display a graphical representation of the processing results of the data received from the computing system 500, such as the data related to the performance of each SoW 312 and/or dies included in the SoW 312. Furthermore, the computing device 510 may provide an interface to provide commands to partition the SoW. For example, the user may logically partition the SoW by generating one or more commands that specify the partitioning information.

In some applications, the computing system 500 can include one or more controllers (not shown in FIG. 5A) to provide data to the computing device 510. For example, one or more controllers can be implemented in the cabinet 120 of FIG. 1 and provide the data, such as configuration information of the computing tiles 102 of FIG. 1 in the cabinet 120, performance data of each computing tiles 102, performance data of dies of the computing tiles 102, etc. In addition, the hosts 202 of FIG. 2 can include a controller, and the controller can provide the configuration information of the computing tiles 102 in the system tray 100 to the computing device 510. In some embodiments, the controller can receive instructions from the computing device 510 and process data based on the received instructions. For example, the computing device 510 can perform partitioning of the SoWs and request data, such as performance metrics of the partitioned SoWs. In this example, the controller may identify the partitioned SoWs and process the performance metrics, such as usage of die(s), bandwidth, and/or latency, and transmit the processed performance metrics to the computing device 510.

The computing device 510 can also be configured to manage the configuration of computing tiles 102. More specifically, the computing device 510 can manage the configuration by identifying each computing tile 102 based at least on the identifier of the computing tiles 102, the location of the computing tiles 102, and the configuration information of the computing tiles 102.

FIG. 5B illustrates an example of a command interface 530 according to the embodiments disclosed herein. The information shown in FIG. 5B can concisely define a partition of a computing system. The commanding interface 530 can provide various fields to identify the configuration of the SoW array 310 and the configuration of dies 322 included in each SoW 312. As illustrated in FIG. 5B, the command interface 530 may include a SoW array configuration field 532, a definition field 534, a SoW configuration field 536, and an address field 538. Together, the information in these fields can define a partition of a computing system. The fields in the command interface 530 can be based on a 2-dimensional coordinate system and be specified based on a starting coordinate (e.g., top-left) and an ending coordinate (e.g., bottom-right). The partition generator can be aware of the hardware to select a partition based on these coordinates. The partition generator can apply certain boot time configuration values, such as a power supply voltage and a clock frequency for individual dies. The fields, as illustrated in FIG. 5B are merely described as examples, and the more or less fields can be used based on specific applications.

The SoW array configuration field 532 can provide the SoW array configuration. For example, as illustrated in FIG. 5B, the SoWs are arranged in an array (e.g., six SoWs defined as SoW 0-5), as shown in field 532. This arrangement can correspond to the computing tiles 102 arrangement included in the system tray 100 of FIG. 1.

The definition field 534 can be utilized to define each SoW configuration information. For example, the definition field 534 in FIG. 5B includes the name, location, IP address, and host address for each SoW. Thus, each SoW can be defined with such field information.

The SoW configuration field 536 can define the configuration information of each SoW. For example, the name is the SoW identification number that can be assigned to each SoW. However, this representation is merely provided as an example, and any other suitable identification number can be used in accordance with any suitable principles and advantages disclosed herein. The location in this specific example of FIG. 5B can be defined based on the cabinet 120. For example, the SoW 0 is included in system tray 100 of the cabinet 120, and the location field can identify the cabinet 120 that includes the SoW 0. The SoW configuration field 536 can further provide interface processing information for each die 322 of the SoW. For example, as shown in FIG. 5B, the dies 322 (U04, U03, U02, U01, U00) of the SoW 0 are identified with host name and a channel number of the NIP 204 of FIG. 2. For instance, as described in FIG. 2, the host 202 can provide the host name of each corresponding SoWs, and the NIPs 204 can provide a specific channel number that each die of the SoW is connected to.

The address field 538 can further provide the specific host address and name In the higher hierarchy that corresponds to a group of the dies 322 (U04, U03, U02, U01, U00).

The partition generator running on the device 510 can manage illegal configurations. The partition generator can abstract away certain information that can be things that can be derived from information provided in the command interface 530 and still follow certain rules for partitioning. For example, the partition generator can prevent partitions from being generated with overlapping hardware resources. This can result from the partition generator being aware of all existing partitions on a hardware system. As another example, the partition generator may not allow an IP reuse as it has in-built checks to avoid IP collisions. As one more example, there is no duplication of information in the system specification schema and hence its can be resilient to user input errors. The final system configuration is derived and is correct by construction.

In some embodiments, the computing device 510 can partition the SoWs. FIG. 5C illustrates an example of a SoW array and dies included in each SoW, according to embodiments disclosed herein. For instance, SoWs are arranged in 2 by 3 array (e.g., six SoWs) and can be implemented in a system tray 100 of the cabinet 120. As illustrated in FIG. 5C, each SoW includes 5 by 5 die array 320. In some embodiments, the computing device 510 may logically combine each array of the SoWs. For example, the combined SoWs can have a 15 by 10 arrays of dies. The number of arrays and each type of arrays illustrated in FIG. 5C are merely provided as examples, and these numbers and types can be determined based on specific applications.

In various embodiments, the computing device 510 can provide a command interface 550 to perform partitioning of the SoWs, as illustrated in FIG. 5C, for example. As illustrated in FIG. 5D, the command interface 550 can define partitions of the SoWs, such as partitions 552 and 556. The partition 552, as represented in FIG. 5D, provides the partition start and end information and as illustrated by partition 554 shown in FIG. 5C. The partition 554, as shown in FIG. 5C corresponds to the partition start and end information shown in partition 556 of FIG. 5D. In various embodiments, the computing device 510 provides specific operational parameters for each partition. The operational parameters can include but are not limited to supply voltage (Vdd), clock frequency, clock, routing information, interface information, etc. In some embodiments, these partitions can be operated with these operational parameters upon booting the computing system. In some applications, the partitioned SoWs can be used for debugging and testing purposes before being implemented in the computing system. For example, the partition 554 can be tested with various operational parameters before installing the system tray 100 in a cabinet 120.

In some embodiments, the computing device 510 can generate a graphical representation of dies that represents the current operational status of the dies. The operational status of the dies can include but is not limited to a functional die (e.g., functional die 560 of FIG. 5E), a non-functional die (e.g., non-functional die 566 of FIG. 5E), and partially functional die (e.g., partially functional die 570 of FIG. 5E). For example, the functional dies can represent the dies that can perform computations so that these dies can be used for performing the computational task as a part of the computing system. The non-functional dies 566 can represent the dies that cannot perform computation tasks or system routing. Furthermore, the non-functional dies 566 can represent the dies that have an error (e.g., functional error) or disabled dies. The partially functional dies 570 can represent the dies that can perform a subset of functions of the functional dies 560. For example, the partially functional dies 570 can perform signal routing functions and not perform computing functions in certain applications.

FIG. SE illustrates an example of graphical representation of 3 by 2 array SoWs (e.g., SoWs 0-5). The graphical representation in FIG. 5E identifies different partitions with a specific shading for each of the dies of a particular partitions. The graphical representation can be generated based on accessing a configuration information defining partition(s) and other computing system information. The configuration information can include any suitable information represented in FIG. 5B and/or FIG. 5D.

As illustrated in FIG. 5E, each SoW can be identified with a specific address, such as a host Internet protocol address 564 corresponding to each SoW. The computing device 510 may generate the graphic representation of the current operational status of each die. For example, as illustrated in FIG. SE, the functional dies 560 can be represented with a specific marker, color, etc. Further, in this example, the non-functional dies 566 can be represented a unique marker, such as the X shown on the non-functional dies 566 of FIG. 5E. Furthermore, the partially functional dies 570 can be represented with an annotation, such as dies 570, as shown in FIG. 5E. In some instances, the partially functional dies can be used for routing data between other dies and not for computing functionality.

In various applications, the user (e.g., system engineer, operator, administration, etc.) of the computing system can partition the SoWs based on these graphical representations. For example, after identifying the unavailable dies 566, the computing device 510 can partition the SoWs by using the command interface 550. For example, the partition input, such as partition start: [0, 0], partition end: [7, 4], may provide the partition 562. In another example, the partition input, such as partition start: [0, 5], partition end: [4, 9], may provide the partition 568. Thus, these partitions 562, 568 may only include the available dies 560. Furthermore, the graphical representations shown in FIG. 5E may facilitate debugging, assembling the SoW, or maintenance process of the computing system. Through the present disclosure, the each die in an array of dies is represented in a form of [y-coordinate, x-coordinate]. For example, a die 592 shown in FIG. 5C can be represented as [9, 0]. However, this representation is merely provided as an example, and any other suitable indexing can be used in accordance with any suitable principles and advantages disclosed herein.

The computing device 510 can also generate partition views of the SoWs. These views can include details of the functionality of nodes of a die. In some applications, the computing device 510 can generate the partition view that includes details of individual dies. FIG. 5F illustrates an example of the partition view of the 2 by 2 dies 574, as shown in FIG. 5C. For example, the computing device 510, via the command interface 550 or other user input, can partition the SoW, such as with the command instruction that “partition start: [1,5], partition end: [2,6],” corresponding to partition 574, as shown in FIG. 5C. Illustratively, after the partition, the computing device 510 can generate the partition view as shown in FIG. 5F. In some embodiments, the computing device 510 may generate queries to receive the performance metric of each die. The performance metric of the dies, for example, can include its availability, available bandwidth, power, voltage, current, temperature, etc. Upon receiving the performance metrics, the computing device can mark each die based on the received performance metrics. For example, the computing device 510 may determine, for each node of a die, whether the performance metric is at or below its threshold. Alternatively, or additionally, the computing device 510 can determine whether there is a failure at any node of a die. Upon determining that the performance metric is at or below its threshold or there is failure, the computing device 510 may plot each die with a mark, such as color, pattern, or any like visual representation. For instance, as shown in FIG. 5F, nodes of a die with the performance metric at or below its threshold or a failure is represented with different color or shading 576.

The graphical representation shown in FIG. 5F can be useful in determining where a failure is in a computing system. In some embodiments, the computing device 510 can generate the graphical representation of FIG. 5F for use in debugging errors within the partition. For example, as illustrated in FIG. 5F, an error (e.g., performance degradation or failure) is generated from the interface portion 572 and spread into other nodes of the same die and another dies. The error can be identified by an engineer with knowledge of the computing system.

With the graphical representation shown in FIG. 5F, the error can be identified faster and/or more easily than by parsing through log files. Even log files are parsed for known patterns, the graphical representation of FIG. 5F is useful to identify one or more unknown failure patterns. This graphical representation can fast-track the debugging and/or root-cause analysis by orders of magnitude.

The pattern in the graphical representation of FIG. 5F may indicate that there is a failure at interface 572. Data can be re-routed around interface 572 to operate the associated die without errors. In some applications, the various error patterns of the SoW can be stored in a storage medium of the computing device 510. These stored patterns can be used to determine the specific errors associated with specific patterns. For example, upon determining a certain error pattern, the computing device 510 may compare the determined error pattern with the stored error patterns to facilitate the debugging process. Even though FIG. 5F illustrates a 2 by 2 array of dies, any suitable principles and advantages of this graphical representation can be applied to any other suitable die array or individual die, In addition, the computing device 510 may provide a user interface functionality to zoom in or out the specific SoW to represent a detail view of each die.

Partitioning disclosed herein can be applied in a variety of useful ways. Dynamic partition generation schemes can be implemented where application software can request various size/configurations of partitions at run time and the partition generation disclosed herein can implement that. Dynamic partition generation scheme for system level Testing (SLT) of computing tiles prior to datacenter deployment can be implemented. For example, each computing tile can be partitioned as overlapping 2×2 logical partitions that can be unit tested. The partition generator can be used to create wraparound partitions e.g., a 2×2 die partition that includes corner dies of the same SoW. This can be accomplished in the partition generator by instantiating the same computing tile 4 times and then defining the partition of 2×2 dies of the corner dies. Another aspect of the partition generator is that the partition generator can work with dead hardware annotations as well when working on SLT.

In various embodiments, the computing device 510 can test a SoW and/or a system tray prior to deploying it in the computing system. For example, prior to a new SoW 582 is deployed into the computing system, the performance and connectivity of SoW 582 can be tested by utilizing the partitioning aspect of the computing device 510. In some applications, the dies (U00, U04, U40, and U44) of the SoW 582 are utilized as interface dies to communicate with the neighboring SoWs surrounding the SoW 582. In these applications, the computing device 510 can generate logical duplication of the SoW 582 to generate 4 instances of the SoW 582, as illustrated in FIG. 5G. Then, the computing device 510 can generate a partition 584 that includes four corner dies of different instances of the SoW 582. For example, after generating the duplicated SoWs, the array dimension can be 10 by 10 array, and the duplicated SoWs can be partitioned with a command, such as “partition start: [4,4] and partition end: [5, 5]” that correspond to partition 584 shown in FIG. 5G. The partition 584 can provide the interface dies (U00, U04, U40, and U44) of the SoW 582. Thus, the partition 584 can be tested and debugged in prior to deploying the SoW 582 to the computing system. This is advantageous because corner dies of the SoW 582 can be tested without connecting to other SoWs and the connectivity of these corner dies can be verified before connecting the SoW 582 to other SoWs.

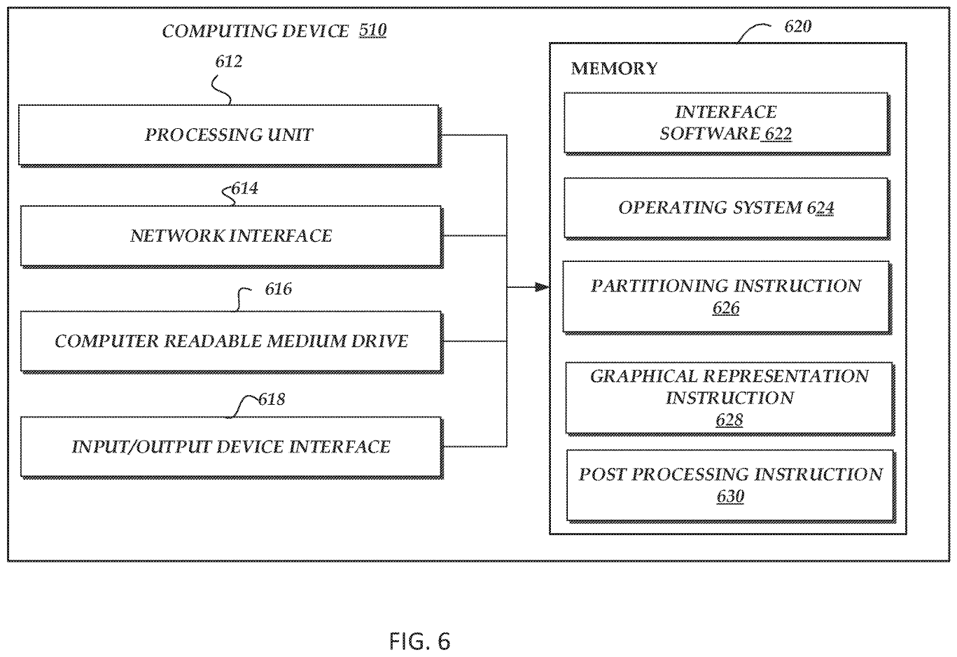

FIG. 6 depicts one embodiment of the architecture of a computing device 510, according to some embodiments disclosed herein. The general architecture of the computing device 510 depicted in FIG. 6 can include an arrangement of computer hardware and software components that may be used to implement aspects of the present disclosure. As illustrated, the computing device 510 can include a processing unit 612, a network interface 614, a computer-readable medium drive 616, and an input/output device interface 618, all of which may communicate with one another by way of a communication bus. The processing unit 612 can be configured to provide computing resources to execute one or more instructions provided by the memory 620. The network interface 614 can be configured to interact with the computing system, as disclosed herein. The network interface 614 can provide various network interfaces that can include any combination of wired and/or wireless networks, such as one or more direct communication channels, local area networks, wide area networks, personal area networks, and/or the internet. The network could also be a specific type of data bus used for transmitting data. The computer readable medium drive 616 can provide storage medium in accordance with one or more embodiments disclosed herein. For example, the computer readable medium drive 616 can store various SoWs configurations and die arrangements. In another example, the computer readable medium drive 616 can store various error patterns that occurred in SoWs (e.g., dies included in SoWs) and also any debugging method and corrective actions applied to these various error patterns. The input/output device interface 618 can provide the interface to various computing components, such as input components (e.g., keyboard and mouse) and output components (e.g., monitor).

The memory 620 may include computer program instructions that the processing unit 612 executes in order to implement one or more embodiments. The memory 620 generally includes RAM, ROM, or other persistent or non-transitory memory. The memory 620 may store an operating system 624 that provides computer program instructions for use by the processing unit 612 in the general administration and operation of the computing device 510. The memory 620 may further include computer program instructions and other information for implementing aspects of the present disclosure. For example, in one embodiment, the memory 620 can include interface software 622 for communicating with other components.

The memory may include the partitioning instruction 626. The partitioning instruction 626 can be utilized to partition (e.g., logical partition) the SoWs. In some applications, the partitioning instruction 626 can be utilized to manage the configuration of computing tiles 102. More specifically, the computing device 510, by providing instructions via the partitioning instruction 626, can manage the configuration by identifying each computing tiles based at least on the identifier of the computing tiles 102, location of the computing tiles 102, and configuration information of the computing tiles 102. As described in FIG. 5B, the commanding interface 530 can provide various fields to identify the configuration of the SoW array 310 and the configuration of dies 322 included in each SoW 312. In addition, the commanding interface 530 may include a SoW array configuration field 532, a definition field 534, a SoW configuration field 536, and an address field 538. The SoW array configuration field 532 can provide the SoW array configuration. For example, as illustrated in field 532 of FIG. 5B, the SoWs are arranged an array (e.g., six SoWs defined as SoW 0-5). This arrangement can correspond to the computing tiles 102 arrangement included in the system tray 100 (shown in FIG. 1). The definition field 534 can be utilized to define each SoW configuration information. For example, the definition field 534 in FIG. 5B includes the name, location, IP address, and host address of each SoW. Thus, each SoW can be defined with these field information. The SoW configuration field 536 can define the configuration information of each SoW. For example, the name is the SoW identification number that can be assigned to each SoW. However, this identification number is merely provided as an example, and any other suitable types of identifier can be used in accordance with any suitable principles and advantages disclosed herein. The location in this specific example of FIG. 5B can be defined based on the cabinet 120. For example, the SoW 0 is included in a system tray 100 of the cabinet 120, and the location field can identify the cabinet 120 that include the SoW 0. The SoW configuration field 536 can further provide interface processing information of each 322 of the SoW. For example, as shown in FIG. 5B, the dies 322 (U04, U03, U02, U01,U00) of the SoW 0 are identified with host name and a channel number of the NIP 204 (shown in FIG. 2). For instance, as described in FIG. 2, the host 202 can provide the host name of each corresponding SoWs, and the NIPs 204 can provide specific channel number that each die of the SoW is connected to. The address field 538 can further provide the specific host address and name in the higher hierarchy that corresponds to a group of the dies (U04, U03, U02, U01, U00). The fields illustrated in FIG. 5B are merely described as examples, and the more or less fields can be used based on specific applications.

In some embodiments, the computing device 510 by utilizing the partitioning instruction 626 can partition the SoWs. FIG. 5C illustrates an example of SoW array and dies included in each SoW. For instance, SoWs are arranged in 2 by 3 array (e.g., six SoWs) and can be implemented in a system tray 100 of the cabinet 120. As illustrated in FIG. 5C, each SoW can include 5 by 5 die array 320. In some embodiments, the computing device 510 may provide instruction to logically combine each array of the SoW. For example, the combined SoWs can have the 15 by 10 arrays of dies. The number of arrays and each type of arrays illustrated in FIG. 5C are merely provided as examples, and these numbers and types can be determined based on specific applications.

In various embodiments, the partitioning instruction 626 can also be provided via a command interface 550 to perform partitioning the SoWs as illustrated in FIG. 5C, for example. As illustrated in FIG. 5D, the command interface 550 can define partitions of the SoWs, such as partitions 552 and 556. The partition 552, as represented in FIG. 5D, provides the partition start and end information and as illustrated by partition 554 shown in FIG. 5C. The partition 554, as shown in FIG. 5C corresponds to the partition start and end information shown in partition 556 of FIG. 5D. In various embodiments, the computing device 510 provides a specific operational parameters for each partition. The operational parameters can include but are not limited to supply voltage (Vdd), clock frequency, clock, routing information, interface information, etc. In some embodiments, these partitions can be operated with these operational parameters upon booting the computing system. In some applications, the partitioned SoWs can be used for debugging and testing purposes before being implemented in the computing system. For example, the partition 554 can be tested with various operational parameters before installing the system tray 100 in a cabinet 120.

The memory 620 can also include a graphical representation instruction 628. The computing device 510 by utilizing the graphical representation instruction 628 can provide instruction to the processing unit 612 to generate a partition view of the SoWs.

In some embodiments, the computing device 510 can execute the graphical representation instructions to generate a graphical representation of dies that represents the current operational status of the dies. This can include accessing a configuration information defining the partitions. Additional computing system information regarding the operational status and/or performance of the dies can also be accessed. The operational status of the dies can include but is not limited to a functional die, a non-functional die, and a partially functional die. For example, the functional dies can represent the dies that can perform computation so that these dies can be used for performing the computational task as a part of the computing system. The non-functional dies can represent the dies that cannot perform the computation task, such as dies that do not meet specific specifications to perform the task or computations. Furthermore, the non-functional dies can represent the dies that have an error (e.g., functional error) or disabled dies. The partially functional dies can represent the dies that can perform a subset of functions of a functional die, such as specific functions other than computations. For example, the specific functions can include but are not limited to the routing function, interface function, and the like. As illustrated in the above FIG. 5E, each SoW can be identified with a specific address, such as a host internet protocol address 564 corresponding to each SoW. The computing device 510 may generate a graphical representation of the current operational status of each die. For example, as illustrated in FIG. 5E, the functional dies 560 can be represented with a specific marker, color, etc. Further, in this example, the non-functional dies 566 can be represented a unique marker, such as shown in the partially functional dies 566 of FIG. 5E. Furthermore, the limited purpose die can be represented with an annotation, such as dies 570, as shown in FIG. 5E.

In various applications, the user (e.g., system engineer, operator, administration, etc.) of the computing system can partition the SoWs based on these graphical representations. For example, after identifying the unavailable dies 566, the computing device 510 can partition the SoWs by using the command interface 550. For example, the partition input, such as partition start: [0, 0], partition end: [7, 4], may provide the partitioned area 562. In another example, the partition input, such as partition start: [0,5], partition end: [4, 9], may provide the partitioned area 568. Thus, these partitions 562, 568 may only include the available dies 560. Furthermore, the graphical representations shown in FIG. 5E may facilitate debugging, assembling the SoW, or maintenance process of the computing system.

In some applications, the processing unit 612 can execute the instructions to generate the partition view in die level. FIG. 5F illustrates an example of the partition view of the 2 by 2 dies 574, as shown in FIG. 5C. For example, the computing device 510 may provide the command interface 550 and may partition the SoW (by executing partitional instruction 626), such as with command instruction that “partition start: [1,5], partition end: [2,6]” that corresponds to partition 574 shown in FIG. 5C. Illustratively, after the partition, the computing device 510 may execute the graphical representation instruction 628 and can generate the partition view as shown in FIG. 5F. In some embodiments, the computing device 510 may generate queries to receive the performance metric of each die. The performance metric of the dies, for example, can include its availability, available bandwidth, power, voltage, current, temperature, etc. Upon receiving the performance metrics, the computing device can mark each die based on the received performance metrics. For example, the computing device 510 may determine, for each die, whether the performance metric is at or below its threshold. Upon determining that the performance metric is at or below its threshold, the computing device 510 may plot each die with a mark, such as color, pattern, or any like visual representation. For instance, as shown in FIG. 5F, the die with the performance metric at or below its threshold is represented with a different color 576.

The memory 620 can also include a post processing instruction 630. In some embodiments, the processing unit 512 may execute the post processing instruction 630 to debug the dies based on the generated partition view. In some embodiments, the computing device 510 by executing the post processing instruction 630 can generate the graphical representation of FIG. 5F for use in debugging errors within the partition. For example, as illustrated in FIG. 5F, an error (e.g., performance degradation or failure) is generated from the interface portion 572 and spread into other nodes of the same die and other dies. The error can be identified by an engineer with knowledge of the computing system.

With the graphical representation shown in FIG. 5F, the error can be identified faster and/or more easily than by parsing through log files. Even log files are parsed for known patterns, the graphical representation of FIG. 5F is useful to identify one or more unknown failure patterns. This graphical representation can fast-track the debugging and/or root-cause analysis by orders of magnitude.

The pattern in the graphical representation of FIG. 5F may indicate that there is a failure at interface 572. Data can be re-routed around interface 572 to operate the associated die without errors. In some applications, the various error patterns of the SoW can be stored in a storage medium of the computing device 510. These stored patterns can be used to determine the specific errors associated with specific patterns. For example, upon determining a certain error pattern, the computing device 510 may compare the determined error pattern with the stored error patterns to facilitate the debugging process. Even though FIG. 5F illustrates a 2 by 2 array of dies, any suitable principles and advantages of this graphical representation can be applied to any other suitable die array or individual die. In addition, the computing device 510 may provide a user interface functionality to zoom in or out the specific SoW to represent a detailed view of each die.

In various embodiments, the computing device 510, by executing the post processing instruction 630, can test a SoW and/or a system tray prior to deploying it in the computing system. For example, prior to a new SoW 582 is deployed into the computing system, the performance and connectivity of SoW 582 can be tested by utilizing the partitioning aspect of the computing device 510. In some applications, the dies (U00, U04, U40, and U44) of the SoW 582 are utilized as interface dies to communicate with the neighboring SoWs surrounding the SoW 582. In these applications, the computing device 510 can generate logical duplication of the SoW 582 to generate 4 instances of the SoW 582, as illustrated in FIG. 5G. Then, the computing device 510 can generate a partition 584 that includes four corner dies of different instances of the SoW 582. For example, after generating the duplicated SoWs, the array dimension can be 10 by 10 array, and the duplicated SoWs can be partitioned with a command, such as “partition start: [4,4] and partition end: [5, 5]” that correspond to partition 584 shown in FIG. 5G. The partition 584 can provide the interface dies (U00, U04, U40, and U44) of the SoW 582. Thus, the partition 584 can be tested and debugged in prior to deploying the SoW 582 to the computing system. This is advantageous because corner dies of the SoW 582 can be tested without connecting to other SoWs and the connectivity of these corner dies can be verified before connecting the SoW 582 to other SoWs.

The computing system disclosed herein can be implemented in a variety of processing systems. Such processing systems can used in and/or specifically configured for high performance computing and/or computationally intensive applications, such as neural network training, neural network inference, machine learning, artificial intelligence, complex simulations, or the like. In some applications, the processing system can be used to perform neural network training. For example, such neural network training can generate data for an autopilot system for vehicle (e.g., an automobile), other autonomous vehicle functionality, or Advanced Driving Assistance System (ADAS) functionality.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

The foregoing description has been described with reference to specific embodiments. However, the illustrative discussions above are not intended to be exhaustive or to limit the inventions to the precise forms described. Many modifications and variations are possible in view of the above teachings. Others skilled in the art are thereby enabled to best utilize the techniques and various embodiments with various modifications as suited to various uses.

Although the disclosure and examples have been described with reference to the accompanying drawings, various changes and modifications will become apparent to those skilled in the art. Such changes and modifications are to be understood as being included within the scope of the disclosure.

What is claimed is:

1. A computing device for generating a graphical representation of a computing system, the computing device comprising:
a computing processor and a memory storing computer-executable instructions, that when executed by the computing processor, cause operations to be performed, the operations comprising:
accessing configuration information identifying partitions of the computing system, wherein the computing system comprises an array of system on wafers (SoWs), and each SoW of the array of SoWs comprises an array of dies; and
generating a graphical representation of at least a portion of the computing system, wherein the graphical representation identifies the partitions and individual dies of the partitions.

2. The computing device of claim 1, wherein the graphical representation provides information associated with functionality of the individual dies of the partitions.

3. The computing device of claim 2, wherein the information associated with functionality of individual dies of the partitions indicates whether each of the individual dies is functional, partially functional, or non-functional.

4. The computing device of claim 1, wherein the configuration information defines a voltage supply level and a clock frequency for each of the partitions.

5. The computing device of claim 1, wherein the operations further comprise checking for an illegal configuration of the configuration information.

6. The computing device of claim 1, wherein the operations further comprise dynamically generating the partitions.

7. The computing device of claim 1, wherein the operations further comprise generating a second graphical representation of dies of a partition of the partitions, and the second graphical representation indicates an error on one or more nodes of a particular die of the partition.

8. The computing device of claim 1, further comprising a display configured to display the graphical representation.

9. A method of generating a graphical representation of a computing system, the method comprising:
accessing configuration information identifying partitions of the computing system, wherein the configuration information is stored in memory, wherein the computing system comprises an array of system on wafers (SoWs), and each SoW of the array of SoWs comprises an array of dies; and
generating, with a computing device, a graphical representation of at least a portion of the computing system, wherein the graphical representation identifies the partitions and individual dies of the partitions.

10. The method of claim 9, wherein the graphical representation provides information associated with functionality of the individual dies of the partitions.

11. The method of claim 10, wherein the information associated with functionality of individual dies of the partitions indicates whether each of the individual dies is functional, partially functional, or non-functional.

12. The method of claim 9, wherein the configuration information defines a voltage supply level and a clock frequency for each of the partitions.

13. The method of claim 9, further comprising checking for an illegal configuration of the configuration information.

14. The method of claim 9, further comprising dynamically generating the partitions.

15. The method of claim 9, further comprising generating a second graphical representation of dies of a partition of the partitions, wherein the second graphical representation indicates an error on one or more nodes of a particular die of the partition.

16. The method of claim 9, further displaying graphical representation on a display.

17. Non-transitory computer-readable storage medium comprising instructions that, when executed by one or more processors, cause the method of claim 9 to be performed.
